(19) United States
(12) Patent Application Publication
(10) Pub. No.: US 2011/0073582 A1
(43) Pub. Date: Mar. 31, 2011

(54) Steering wheel

(75) Inventors: Bunpei Morita, Kiyosu-shi (JP); Norio Umemura, Kiyosu-shi (JP); Kosuke Shigeta, Kiyosu-shi (JP)

(73) Assignee: TOYODA GOSEI CO., LTD., Kiyosu-shi (JP)

(21) Appl. No.: 12/923,204

(22) Filed: Sep. 9, 2010

(30) Foreign Application Priority Data
Sep. 30, 2009 (JP) 2009-226278
Mar. 30, 2010 (JP) 2010-079726

(51) Int. Cl. B62D 1/06; H05B 3/34

(52) U.S. Cl. 219/204

(57) ABSTRACT

A steering wheel includes a rim metal core, a rigid covering member, a heating element, and a cover. The rim metal core forms the framework of the rim. The rigid covering member is provided about at least a part in the circumferential direction of the rim metal core. The heating element is formed by a flexible sheet having a heat generating member that generates heat when electrified. The heating element is arranged along the outer surface of the covering member. The cover is provided about the heating element and has an outer surface that serves as an ornamental surface of the rim. A hollow portion (an air layer) is formed between the rim metal core and a part of the covering member at which the heat generating member (a resistor layer) of the heating element is located. The hollow portion serves as a heat-insulating layer.

### BACKGROUND OF THE INVENTION

The present invention relates to a steering wheel incorporating in the rim a heat generating member that generates heat when electrified.

When a vehicle is parked in extremely cold weather in winter, the temperature in the passenger compartment is lowered. Accordingly, the temperature of the rim of the steering wheel is lowered. The rim is also referred to as the handle portion or ring portion. When the driver gets in the vehicle in this state and starts driving, he/she needs to grip the cold rim. This can make the steering operation uncomfortable.

In this regard, various types of steering wheels have been known that incorporate in the rim a heat generating member that generates heat when electrified. FIG. 24(A) illustrates one such steering wheel 70 disclosed in Japanese Laid-Open Patent Publication No. 2003-317905 (first prior art device). Specifically, FIG. 24(A) shows the cross-sectional structure of a rim 71. The steering wheel 70 includes a rim metal core 72, which forms the framework of the rim 71. The rim metal core 72 is coated with a rigid coating portion 73 made, for example, of rigid urethane. A sheet-like heat generating member 74 covers the outer surface of the coating portion 73. As shown in FIG. 24(B), the sheet-like heat generating member 74 includes a base fabric sheet 75 formed, for example, by woven fabric or nonwoven fabric, and heating wires 76 arranged on the base fabric sheet 75. The heating wires 76 generate heat when electrified. The heating wires 76 are sewn to the base fabric sheet 75 by means of upper threads 77 and lower threads 78. The sheet-like heat generating member 74 is coated by an elastic member (support body) 79 made of a soft (elastic) material, which is for example, a foam resin as shown in FIG. 24(A). Further, a cover 81 made of leather is wound about the elastic member 79.

Unlike the case where a cover 81 is directly wound about the sheet-like heat generating member 74, asperities of the outer surface of the sheet-like heat generating member 74 hardly stand out on the outer surface 810 of the cover 81 (the ornamental surface of the rim 71). The external appearance is therefore hardly degraded by the sheet-like heat generating member 74.

However, in the above described steering wheel 70, heat generated by the heating wires 76 in the sheet-like heating element is easily transferred through the rigid coating portion 73 to the rim metal core 72, which has good heat conductivity. Accordingly, the amount of heat transferred to the cover 81 is reduced, and the temperature of the cover 81 is not raised as intended. It is therefore desired that a greater proportion of the heat generated by the heating wires 76 be efficiently transferred to the cover 81, so that its temperature is increased.

Further, since the heating wires 76 are sewn to the base fabric sheet 75 by means of the upper and lower threads 77, 78, the manufacture thereof is difficult and costly. This increases the costs of the steering wheel 70.

FIG. 25 illustrates the cross-sectional structure of a rim 171 of a steering wheel 170 according to a second prior art device. The steering wheel 170 includes a rim metal core 172, which forms the framework of the rim 171. The rim metal core 172 is coated with a coating portion 173 made of soft (elastic) material such as foamed polyurethane. A flexible heating element 174 is arranged on the outer surface 173o of the coating portion 173, and a cover 175 is wound about the heating element 174.

FIG. 26 shows one example of the heating element 174, which is formed by arranging heating wires (heat generating members) 177 on a soft fabric sheet 176 as shown in FIG. 26. The heating wires 177 generate heat when electrified (refer to, for example, Japanese National Phase Laid-Open Patent Publication No. 2002-502759).

However, in the steering wheel 170, which employs the prior art heating element 174, parts of the cover 175 that correspond to the heating wires 177 are pushed from below, causing the pattern of the heating wires 177 to stand out. This degrades the external appearance. The parts of the cover 175 that correspond to the heating wires 177 are locally heated and thus contracted. Due to repeated contraction over years, wrinkles will be conspicuous, degrading the external appearance.

Such a problem can be dealt with by providing an elastic member made of rubber such as chloroprene rubber (neoprene rubber) between the heating element 174 and the cover 175. In this case, at positions where the elastic member covers the heating wires 177, only the parts on the inner surface are elastically deformed, so that asperities on the outer surface 174o of the heating element 174 are absorbed. At positions where the elastic member covers the heating wires 177, the parts on the outer surface are hardly influenced by the asperities on the outer surface 174o of the heating element 174. Therefore, the outer surface of the elastic member is smooth. Accordingly, the outer surface of the cover 175 wound about the elastic member is smooth.

However, since the elastic member is used in this configuration, the number of components in the steering wheel is increased. This increases the number of assembly steps, and thus increases manufacturing costs.

### SUMMARY OF THE INVENTION

Accordingly, it is an objective of the present invention to provide a steering wheel that efficiently increases the temperature of a cover, and particularly a steering wheel that efficiently increases the temperature of a cover without increasing the costs.

To achieve the foregoing objective and in accordance with one aspect of the present invention, a steering wheel is provided that includes a rim, a rim metal core that forms the framework of the rim, a rigid covering member, a heating element, and a coating layer. The rigid covering member is provided about at least a part of the rim metal core in the circumferential direction of the rim metal core. The covering member has an outer surface. The heating element is formed by a flexible sheet having a heat generating member that generates heat when electrified. The heating element is arranged along the outer surface of the covering member and has an outer surface. The coating layer is provided on the outer surface of the heating element. The coating layer is softer than the covering member. A hollow portion is formed between the rim metal core and a part of the covering member at which the heat generating member of the heating element is located.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a front view showing a steering wheel according to a first embodiment of the present invention;

FIG. 2 is a front view showing a metal core of the steering wheel of FIG. 1;

FIG. 3 is a schematic side view showing the steering wheel of FIG. 1 as viewed from the left;

FIG. 4 is an enlarged partial front view illustrating a section X in FIG. 1;

FIG. 5 is a cross-sectional view taken along line 5-5 of FIG. 4, illustrating the rim;

FIG. 6 is a cross-sectional view taken along line 6-6 of FIG. 4, illustrating the steering wheel;

FIG. 7 is a cross-sectional view taken along line 7-7 of FIG. 4, illustrating the rim;

FIG. 8 is an exploded cross-sectional view illustrating components of the rim shown in FIG. 7;

FIG. 9 is a front view illustrating a heating element, from which the insulation layer and adhesive layers on both sides are omitted;

FIG. 10 is a partially enlarged cross-sectional view of the heating element;

FIG. 11 is a partial cross-sectional view illustrating a state before the heating element is adhered to a covering member;

FIG. 12 is a front view showing a steering wheel according to a second embodiment of the present invention;

FIG. 13 is a front view showing a metal core of the steering wheel of FIG. 12;

FIG. 14 is a schematic side view showing the steering wheel of FIG. 12 as viewed from the left;

FIG. 15 is an enlarged partial front view illustrating a section X in FIG. 12;

FIG. 16 is a cross-sectional view taken along line 16-16 of FIG. 15, illustrating the rim;

FIG. 17 is a cross-sectional view taken along line 17-17 of FIG. 15, illustrating the steering wheel;

FIG. 18 is a cross-sectional view taken along line 18-18 of FIG. 15, illustrating the rim;

FIG. 19 is an exploded cross-sectional view illustrating the rim metal core, support member, and covering member shown in FIG. 18;

FIG. 20 is a front view illustrating a heating element, from which the insulation sheet is omitted;

FIG. 21 is a partially enlarged cross-sectional view of the heating element;

FIG. 22 is a cross-sectional view illustrating a state in which a steering wheel intermediate is set in a molding apparatus;

FIG. 23 is a partial cross-sectional view taken along line 23-23 of FIG. 22.

FIG. 24(A) is a cross-sectional view of a rim in a steering wheel according to a first prior art;

FIG. 24(B) is an enlarged cross-sectional view illustrating the sheet-like heat generating member in the steering wheel shown in FIG. 24(A);

FIG. 25 is a cross-sectional view of a rim in a steering wheel according to a first prior art; and

FIG. 26 is a cross-sectional view illustrating a heating element incorporated in the steering wheel shown in FIG. 25.

### DETAILED DESCRIPTION OF THE PREFERRED EMBODIMENTS

### First Embodiment

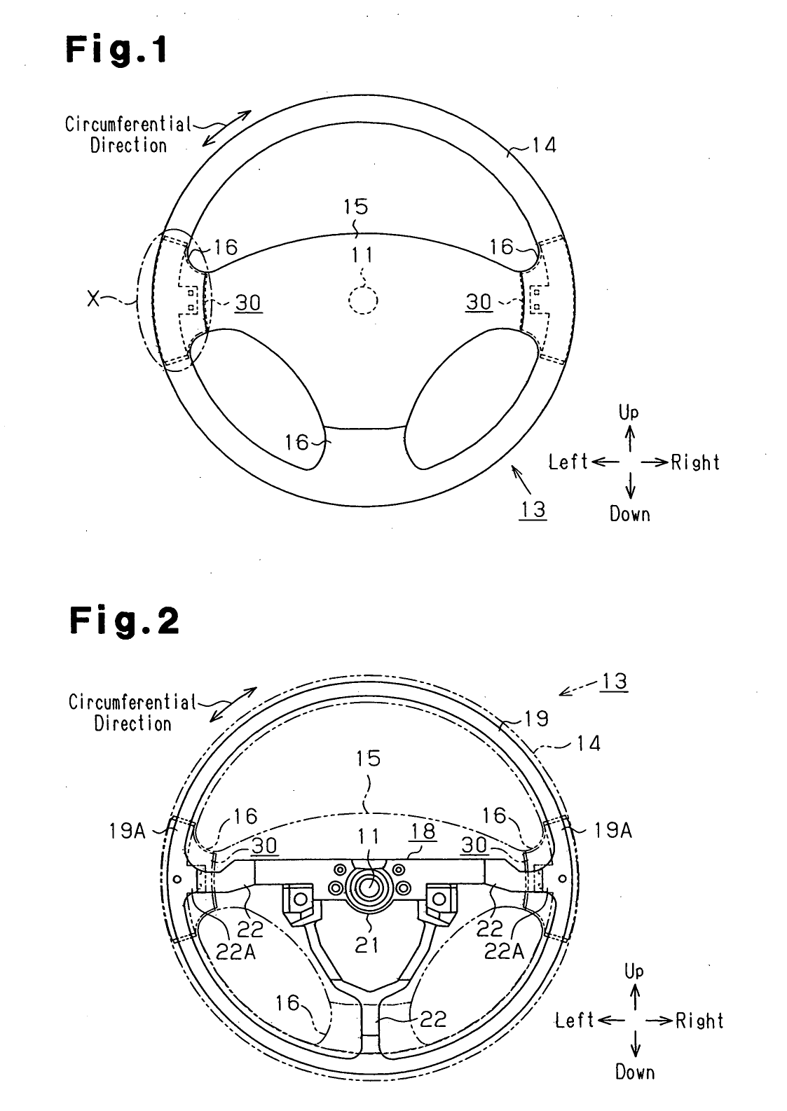

A vehicle steering wheel according to a first embodiment of the present invention will now be described with reference to FIGS. 1 to 11.

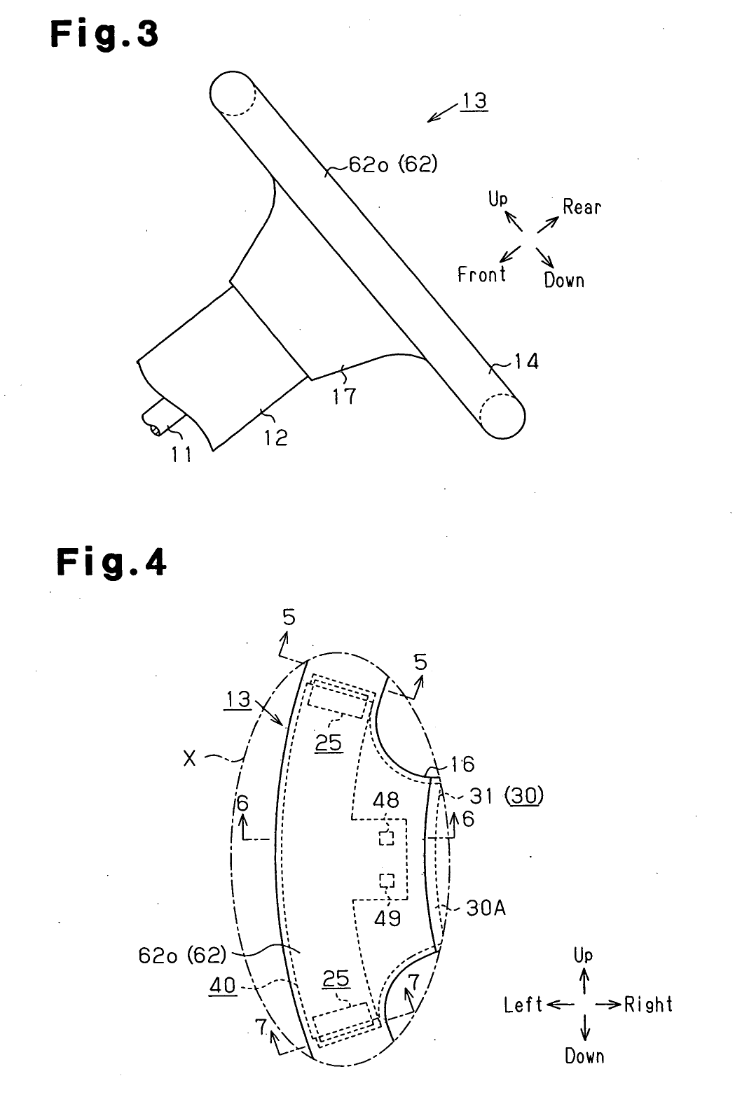

As shown in FIGS. 1 and 3, a steering shaft 11 is provided in front of the driver's seat of a vehicle (on the left side of FIG. 3). The steering shaft 11 is inclined so that its height increases toward the driver's seat (toward the right side of FIG. 3). A steering column cover 12 is provided about the steering shaft 11. The rear end of the steering shaft 11 is coupled to a steering wheel 13 of the present embodiment. The steering wheel 13 is integrally rotatable with the steering shaft 11. The steering wheel 13 includes a rim (also, referred to as a handle portion or a ring portion) 14, a pad 15, spokes 16, and a lower cover 17.

The rim 14 is formed to be annular with its center coinciding with the steering shaft 11 (see FIG. 1). Since the steering shaft 11 is inclined as described above, the steering wheel 13 is inclined so as to approach the driver's seat toward the lower end (see FIG. 3).

The pad 15 is arranged in the space surrounded by the rim 14. The number of spokes 16, which connect the rim 14 and the pad 15 together, is three in the present embodiment. The lower cover 17 is arranged forward of the pad 15 and the spokes 16.

In the present embodiment, the steering shaft 11 is used as a reference when describing each part of the steering wheel 13. A direction along the steering shaft 11 is defined as the front-rear direction of the steering wheel 13. Among directions along a plane perpendicular to the steering shaft 11, a direction in which the steering wheel 13 rises is defined as an up-down direction. Thus, the front-rear direction and the up-down direction of the steering wheel 13 are slightly inclined relative to the front-rear direction (horizontal direction) and the up-down direction (vertical direction) of the vehicle.

To identify the circumferential position of the rim 14, which is rotated during operation, the upward, downward, leftward, and rightward directions are defined with reference to the state when the vehicle is traveling forward in a straight line (the neutral state).

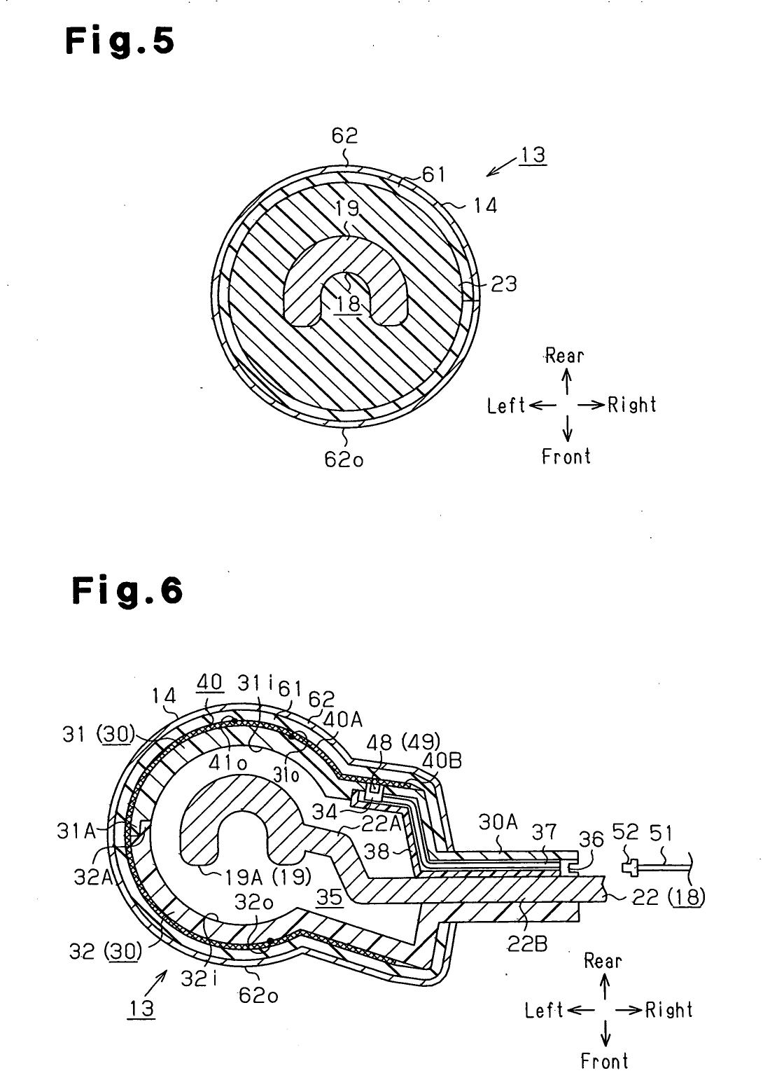

As shown in FIGS. 1 and 2, a metal core 18 is arranged in a space surrounded by the rim 14 of the steering wheel 13, the spokes 16, the pad 15, and the lower cover 17. The metal core 18 is formed, for example, of iron, aluminum, magnesium, or an alloy thereof. The metal core 18 includes a rim metal core 19 located in the rim 14. The rim metal core 19 forms the framework of the rim 14 and has an annular shape as viewed from an occupant (driver). The rim metal core 19 is substantially located at a center in a cross section of the rim 14 along a plane that is perpendicular to the elevation of the drawing and includes the rotational axis of the steering shaft 11 (see FIG. 5).

In addition to the rim metal core 19, the metal core 18 includes a boss metal core 21, which is located slightly forward of the space surrounded by the rim metal core 19. The metal core 18 includes a plurality of (three) spoke metal cores 22, each corresponding to one of the spokes 16. The boss metal core 21 is attached to and rotates integrally with the steering shaft 11. Each spoke metal core 22 includes one end coupled to the boss metal core 21 and another end coupled to the rim metal core 19. Parts at which the left and right spoke metal cores 22 and the rim metal core 19 are coupled together are referred to as coupling portions. Each coupling portion includes a spoke-side coupling portion 22A, which is a part of the spoke metal core 22 that is coupled to the rim metal core 19, and a rim-side coupling portion 19A, which is a part of the rim metal core 19 that is coupled to the spoke metal core 22. Each rim-side coupling portion 19A has an arcuate shape in the front view. Each spoke-side coupling portion 22A is bent in the front-rear direction at positions spaced from each other in the longitudinal direction of the spoke 16 (see FIG. 6).

The structure of the rim 14 is different between a part corresponding to the rim-side coupling portion 19A and a part corresponding to the remaining parts of the rim metal core 19.

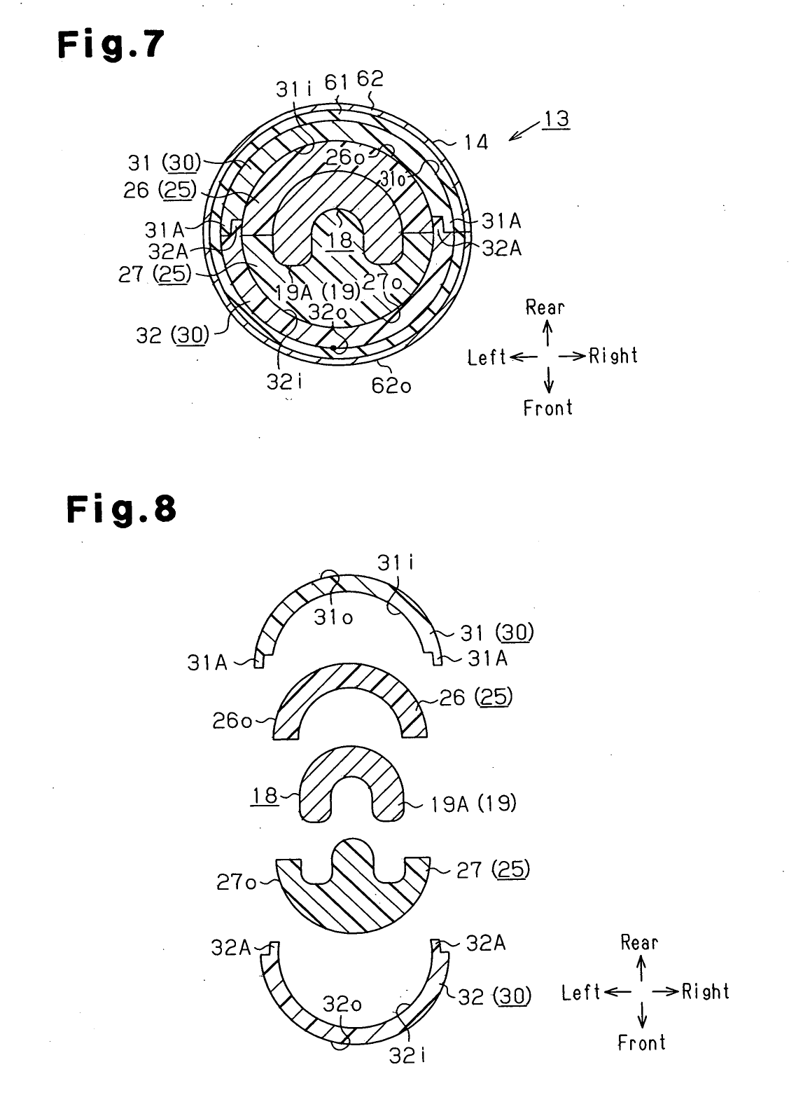

FIG. 4 is an enlarged view of a section X of FIG. 1. FIG. 5 is a cross-sectional view taken along line 5-5 of FIG. 4. FIG. 6 is a cross-sectional view taken along line 6-6 of FIG. 4. FIG. 7 is a cross-sectional view taken along line 7-7 of FIG. 4. In FIGS. 5 to 7, the upper side generally corresponds to the rear side in the vehicle (driver's seat), and the lower side generally corresponds to the front side in the vehicle. FIGS. 5 to 7 show the cross-sectional structure of the left part of the rim 14. The right side has the same cross-sectional structure. Therefore, in the present embodiment, the cross-sectional structure of the left part is described, and description of that of the right part is omitted.

As shown in FIGS. 4 and 5, parts of the rim metal core 19 except for the rim-side coupling portion 19A is coated with a rigid coating portion 23 made of a rigid resin.

As shown in FIGS. 4, 7 and 8, a support member 25 is arranged at each end of the rim-side coupling portion 19A with respect to the circumferential direction of the rim 14 (see FIG. 4). Each support member 25 is divided into two members. To distinguish these members, the member located at the rear will be referred to as a support piece 26, and the member located at front will be referred to as a support piece 27. The support pieces 26, 27 are each formed by an elastic member made, for example, of rubber or silicone. The support piece 26 is fitted from the rear to each end of the rim-side coupling portion 19A with respect to the circumferential direction of the rim 14, and the support piece 27 is fitted from the front. A separating surface of the support piece 27 and a separating surface of the support piece 26 are brought into contact. In this contacting state, the support pieces 26, 27 both closely contact each end of the rim-side coupling portion 19A with respect to the circumferential direction of the rim 14, so as to make the annular support member 25 about each end (see FIG. 7).

As shown in FIGS. 6 to 8, a rigid covering member (also, referred to as a bezel) 30 is attached to the rim metal core 19 and the spoke metal core 22. The covering member 30 is formed to be hollow and made of a rigid resin. The covering member 30 covers the entire rim-side coupling portion 19A and the spoke-side coupling portion 22A. In this attached state, an inner end portion 30A of the covering member 30 covers a part 22B of the spoke metal core 22 that is closer to the boss metal core 21 than the spoke-side coupling portion 22A (right side as viewed in FIG. 6).

The covering member 30 is divided into two members. To distinguish these members, the member located at rear will be referred to as a covering piece 31, and the member located at front will be referred to as a covering piece 32. An inner surface 31i of the covering piece 31 and an inner surface 32i of the covering piece 32 form the inner surface of the covering member 30. Also, an outer surface 310 of the covering piece 31 and an outer surface 32o of the covering piece 32 form the outer surface of the covering member 30.

An engaging portion 31A is formed on the separating surface of the covering piece 31, and an engaging portion 32A is formed on the separating surface of the covering piece 32. The engaging portions 32A are engageable with the engaging portions 31A. The covering piece 32 is fitted from the front to the support piece 27, and the covering piece 32 is fitted to the support piece 26 from rear. The engaging portions 31A of the covering piece 31 are engaged with the engaging portions 32A of the covering piece 32. The engagement causes the covering member 30 to be attached to the rim-side coupling portion 19A and the spoke-side coupling portion 22A with the pair of support members 25 in between. The region surrounded by the rim-side coupling portion 19A, the spoke-side coupling portion 22A, the covering member 30, and the support members 25 defines a hollow portion 35 (see FIG. 6).

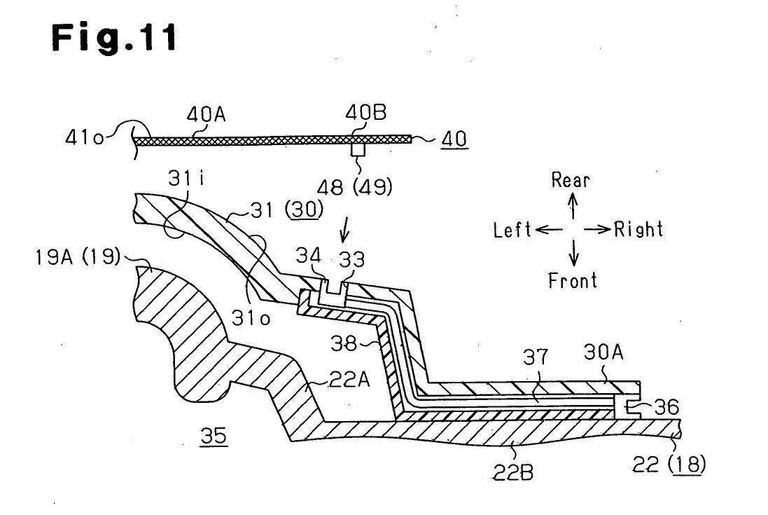

As shown in FIG. 11, two through holes 33 (only one is shown in FIG. 11) are formed in the rear covering piece 31. The through holes 33 connect the exterior and interior of the covering member 30 to each other. The through holes 33 are located in a part that covers the spoke-side coupling portion 22A and are separated from each other with respect to the circumferential direction of the rim 14 (the direction perpendicular to the elevation of the drawing). A first connector 34 is inserted in and fixed to each through hole 33. A part of each fixed first connector 34 is exposed to the outside of the covering piece 31.

Two second connectors 36 (only one is shown in FIG. 11) are fixed to the inner end portion 30A of the covering member 30. More specifically, the two second connectors 36 are inserted and fixed to the part between an end of the covering piece 31 facing the boss metal core 21 (the right end in FIG. 11) and the spoke metal core 22. The two second connectors 36 are separated from each other along the circumferential direction of the rim 14.

Two conductive wire rods are arranged in the covering member 30 to extend along the inner surface 31i of the covering piece 31. In the present embodiment, the wire rods are first electric wires 37, which are formed by coating lead wires with insulating material such as soft resin. One end of each first electric wire 37 (left end as viewed in FIG. 11) is connected to one of the first connectors 34. The other end (right end as viewed in FIG. 11) is connected to one of the second connectors 36. Each first electric wire 37 is used for supplying electricity or signals to a heat generating member of a heating element 40, which will be discussed below, from the outside of the rim 14. Each first electric wire 37 is arranged while being curved along the inner surface 31i of the covering piece 31.

A resin receiving portion 38 for receiving the first electric wires 37 is provided inside the covering piece 31. The receiving portion 38 is formed by a component separate from the covering piece 31 and attached to the covering piece 31 from inside. In most part, the receiving portion 38 is spaced from the inner surface 31i of the covering piece 31 by a constant distance except for the sections that are attached to the covering piece 31. The receiving portion 38 entirely covers the first connectors 34 and the curved first electric wires 37 from front. The receiving portion 38 restricts movement (for example, shaking) of the electric wires 37 and maintains the first electric wires 37 in shapes conforming to the inner surface 31i of the covering piece 31.

The first connectors 34, the first electric wires 37, the second connectors 36, and the receiving portion 38 are attached to the covering piece 31 before the covering piece 31 are placed over the support pieces 26. The receiving portion 38 may receive the first electric wires 37 at several positions that are spaced from each other along the longitudinal direction.

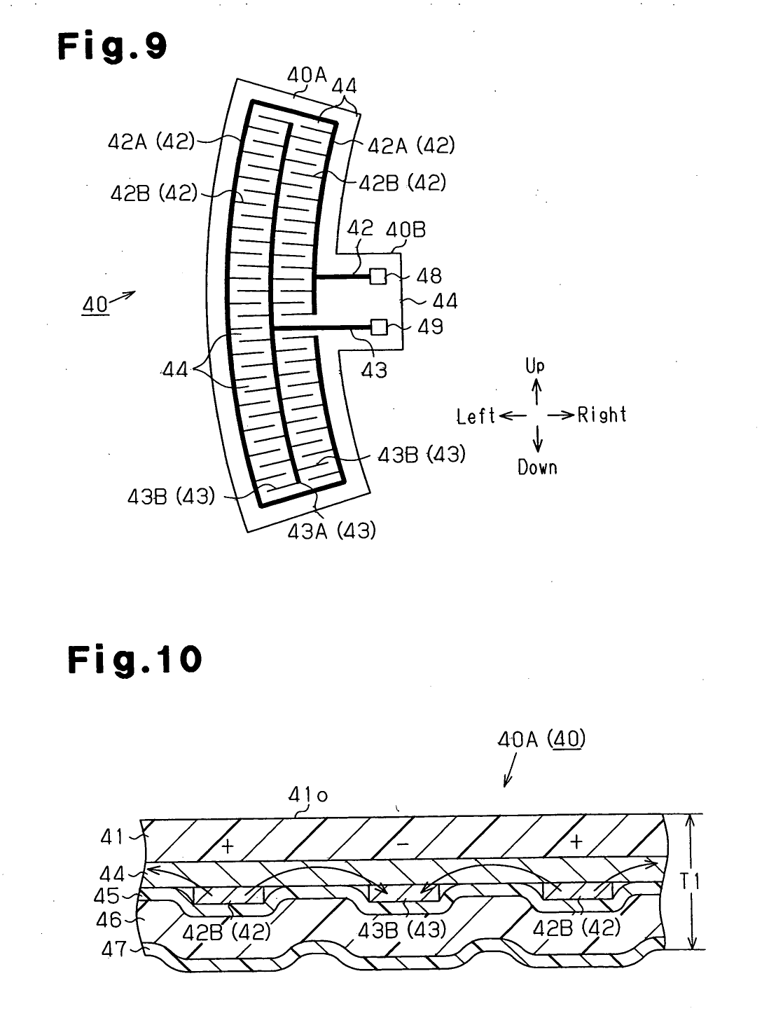

As shown in FIG. 6, a sheet-like heating element 40 is arranged on the covering member 30 at a part corresponding to the hollow portion 35. The heating element 40 is spread along the outer surfaces 31o, 32o of the covering member 30. FIG. 9 shows the heating element 40 as viewed from front, and FIG. 10 is an enlarged cross-sectional view of the heating element 40. FIG. 9 shows the heating element 40 with adhesive layers 45, 47 and an insulation layer 46, which are discussed below, omitted.

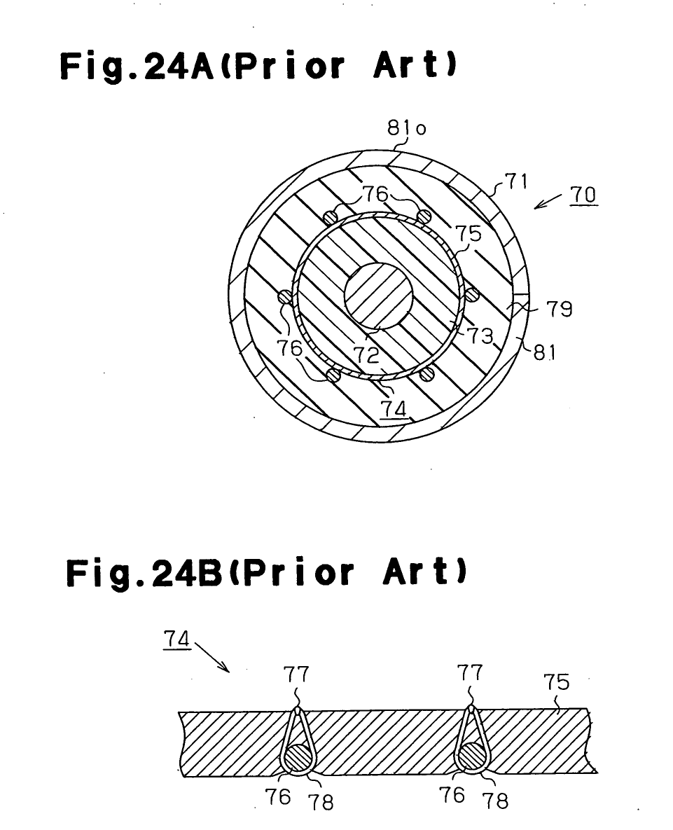

As shown in FIGS. 9 and 10, the main portion of the heating element 40 is a flexible sheet having a sheet-like heat generating member that generates heat when electrified. The heating element 40 of the present embodiment has a slightly greater rigidity than the sheet-like heat generating member 74 of Japanese Laid-Open Patent Publication No. 2003-317905, in which the heating wires 76 are sewn to the base fabric sheet 75 (see FIGS. 24(A), 24(B)). When receiving force, the heating element 40 is flexed, and returns to the original shape when the force is removed. The heating element 40 has a thickness T1, which is 0.2 to 0.3 mm, as a whole.

The heating element 40 includes a sheet-like heating main body 40A, heating a sheet-like extension 40B, and a pair of first terminals 48, 49 (see FIG. 9). The heating main body 40A is arranged on the covering member 30 at a part corresponding to the hollow portion 35. The heating main body 40A is spread along the outer surfaces 31o, 32o of the covering member 30 (see FIG. 6). The extension 40B is located at a position facing the boss metal core 21 (right side in FIG. 9) and overlaps and surrounds the through holes 33. The extension 40B is integrally formed with the main body 40A.

Each of the heating main body 40A and the extension 40B include an insulation sheet 41 serving as an insulative substrate, a resistor layer 44, a pair of electrodes 42, 43, an adhesive layer 45, an insulation layer 46, and an adhesive layer 47.

The insulation sheet 41 is a member that forms one side of the heating element 40 (upper side as viewed in FIG. 10). The insulation sheet 41 is formed by an insulation film such as a polyester film, and has flexibility as a whole. The outer surface 410 of the insulation sheet 41 forms the outer surface of the heating element 40.

The resistor layer 44 forms a heat generating member and is formed substantially over the entire insulation sheet 41. The resistor layer 44 is formed by, for example, printing the following ink and subjecting the printed ink to high temperature baking. The ink is formed by dispersing conductive particles such as carbon particles to insulating organic polymer by means of solvent. The resistor layer 44 may have a positive temperature coefficient (PTC) so that the resistance value increases as the temperature increases. Alternatively, the resistor layer 44 does not need to have the PTC. If the resistor layer 44 has the PTC, its temperature is relatively low and the resistance value is small when electricity starts being supplied. Accordingly, a large current flows through the resistor layer 44, generating a great amount of heat. The resistor layer 44 has high heat conductivity like the electrodes 42, 43, which will be discussed below.

The electrode 42 functions as a positive electrode and has a wide main electrode portion 42A, which extends along the circumferential direction of the rim 14 (up-down direction of FIG. 9) on the resistor layer 44. The other electrode 43 functions as a negative electrode and has a wide main electrode portion 43A, which extends along the circumferential direction of the rim 14 at a position on the resistor layer 44 that is different from the main electrode portion 42A. Comb-like auxiliary electrode portions 42B, which are narrower than the main electrode portion 42A, extend from the main electrode portion 42A toward the other main electrode portion 43A. Likewise, comb-like auxiliary electrode portions 43B, which are narrower than the main electrode portion 43A, extend from the main electrode portion 43A toward the other main electrode portion 42A. The auxiliary electrode portions 42B, 43B are spaced by constant intervals along the circumferential direction of the rim 14. The electrodes 42, 43 are arranged such that the auxiliary electrode portions 42B, 43B are alternately arranged along the circumferential direction of the rim 14. Each adjacent pair of the auxiliary electrodes 42B, 43B function as opposing electrodes.

The electrodes 42, 43 are formed by a printing method, in which conductive ink containing, for example, silver or copper, is applied onto the resistor layer 44. Alternatively, the electrodes 42, 43 can be formed by etching metal foil adhered to the resistor layer 44. In this case, aluminum foil or copper foil is used as the metal foil.

The insulation layer 46 is formed by an insulation film such as a polyester film, and has flexibility. The insulation layer 46 coats and protects the resistor layer 44 and the electrodes 42, 43.

The adhesive layer 45 is formed on one surface (the upper surface as viewed in FIG. 10) of the insulation layer 46, and the adhesive layer 47 is formed on the other surface (the lower surface as viewed in FIG. 10) of the insulation layer 46. The adhesive layers 45, 47 are formed of insulating adhesive compound. The insulation layer 46 is adhered to the resistor layer 44 and the electrodes 42, 43 by means of the adhesive layer 45.

As shown in FIGS. 9 to 11, the first terminals 48, 49 form ports through which currents flow between the electrodes 42, 43 and the outside. The first terminals 48, 49 protrude from the heating element 40 toward the covering member 30 (see FIG. 11). The first terminal 48 functions as a positive terminal and is electrically connected to the electrode 42 by means of a fastener such as a grommet. The first terminal 49 functions as a negative terminal and is electrically connected to the electrode 43 by means of a fastener such as a grommet. The first terminals 48, 49 are connected to the first connectors 34 through the through holes 33 in the covering piece 31. Accordingly, the electrodes 42, 43 are electrically connected to the first electric wires 37 through the through holes 33. This connection determines the position of the heating element 40 in relation to the covering member 30.

An electronic control unit (not shown), which controls electricity supplied to the heating element 40, is provided in the space between the pad 15 (see FIG. 1) and the lower cover 17. As shown in FIG. 6, two second electric wires 51 extend from the electronic control unit (only one is shown in FIG. 6). The second electric wires 51 are formed by coating leading wires are formed by coating lead wires with insulating material such as soft resin. Second terminals 52, which are connectable to the second connectors 36, are connected to the second electric wires 51. The second terminals 52 are detachably connected to the second connectors 36.

The first terminals 48, 49 are connected to the first connectors 34 in the above described manner. In this state, the heating main body 40A is adhered to the outer surfaces 31o, 32o of the covering pieces 31, 32 (see FIG. 6) by means of the adhesive layer 47 (see FIG. 10), while being flexed along the covering pieces 31, 32. Also, the extension 40B is adhered to the outer surface 310 of the covering piece 31 (see FIG. 6) by means of the adhesive layer 47, while being flexed along the covering piece 31.

Although the heating main body 40A and the extension 40B of the present embodiment both have flexibility, the heating main body 40A and the extension 40B are less flexible than the sheet-like heat generating member 74 (see FIG. 24(B)) disclosed in Japanese Laid-Open Patent Publication No. 2003-317905, in which the heating wires 76 are sewn to the base fabric sheet 75. Therefore, compared to the sheet-like heat generating member 74, the heating main body 40A and the extension 40B can be easily and reliably adhered to predetermined positions of the covering member 30 without making wrinkles. Once adhered, the heating main body 40A and the extension 40B are not peeled or displaced and are maintained at the initial positions unless significantly great force is applied.

A cover 62 made of, for example, leather, is wound about the above described rigid coating portion 23 (see FIG. 5) and the heating element 40 (see FIG. 6) by means of a sheet-like elastic member 61, which is made of, for example, rubber (such as neoprene rubber). The outer surface 62o of the cover 62 forms an ornamental surface of the rim 14. The elastic member 61 and the cover 62 form a coating layer that is softer than the covering member 30.

In the steering wheel 13 configured as described above, the electronic control unit outside of the rim 14 supplies electricity and signals to the heating element 40 through the second electric wires 51, the second terminals 52, the second connectors 36, the first electric wires 37, the first connectors 34, and the first terminals 48, 49.

When the vehicle starts being driven in the winter under a low outside temperature condition, a current is supplied to the heat generating member (the resistor layer 44), so that the heat generating member (the resistor layer 44) generates heat. That is, as shown in FIGS. 9 and 10, when the pair of electrodes 42, 43 is electrified through the first terminals 48, 49, current flows in the resistor layer 44 from the auxiliary electrode portions 42B to the auxiliary electrode portions 43B as indicated by arrows in FIG. 10. Accordingly, the resistor layer 44 between the auxiliary electrode portions 42B, 43B generates heat. The resistor layer 44 and the auxiliary electrode portions 42B, 43B both have good heat conductance, the temperature of wide areas on the surfaces increases.

The heat generated by the resistor layer 44 is transferred to the cover 62 through the elastic member 61 coating the heating element 40. The heat transfer uniformly increases the temperature of contacting parts of the elastic member 61 and the cover 62 about the heating element 40, so that the temperature is quickly increased to an adequate level for being gripped by the driver.

The rim metal core 19 is made of metal and has good heat conductivity. Therefore, if the covering member 30 is in direct contact with the rim metal core 19, or the covering member 30 indirectly contacts the rim metal core 19 via the rigid coating portion 173 as in Japanese Laid-Open Patent Publication No. 2003-317905 (see FIG. 24 (A)), the heat generated by the heat generating member (the resistor layer 44) is likely to transferred to the rim metal core 19 through the covering member 30, or through the covering member 30 and the rigid coating portion 173. If heat is transferred to the rim metal core 19, the amount of heat transferred from the heat generating member (the resistor layer 44) to the elastic member 61 and the cover 62 is reduced accordingly.

However, in the present embodiment, the hollow portion (an air layer) 35 between the covering member 30 and the rim-side coupling portion 19A and the spoke-side coupling portion 22A functions as a heat-insulating layer. The hollow portion 35 prevents the heat generated by the heat generating member (the resistor layer 44) of the heating element 40 from being transferred to the rim metal core 19 through the covering member 30. As a result, most of the heat generated by the heat generating member (the resistor layer 44) of the heating element 40 is transferred to parts of the elastic member 61 and the cover 62 that surround the heating element 40.

As shown in FIG. 6, the outer surface 62o of the cover 62 forms the ornamental surface of the rim 14. If the asperities on the outer surface 410 of the heating element 40 (see FIG. 10) stand out on the ornamental surface, the external appearance is degraded. However, in the present embodiment, the elastic member 61 located between the heating element 40 and the cover 62 elastically deforms in accordance with the asperities of the heating element 40 on the inner side, thereby absorbing the asperities on the outer surface of the heating element 40 (the outer surface 410 of the insulation sheet 41). Accordingly, the outer surface of parts of the elastic member 61 that covers the heat generating member (the resistor layer 44) is less likely to be influenced by the asperities of the outer surface of the heating element 40 (the outer surface 410 of the insulation sheet 41), and smooth or substantially smooth. The outer surface 62o of the cover 62 outside the elastic member 61 becomes smooth or substantially smooth, so that the external appearance is prevented from being degraded by the heating element 40.

If the cover 81 is wrapped about the sheet-like heat generating member 74, which is formed by sewing the heating wires 76 to the base fabric sheet 75, as disclosed in Japanese Laid-Open Patent Publication No. 2003-317905, parts of the cover 81 that cover the heating wires 76 are locally heated and contracted. Due to repeated contraction over years, wrinkles will be conspicuous, degrading the external appearance.

However, according to the present embodiment, the resistor layer 44 between the adjacent auxiliary electrode portions 42B and 43B generates heat as shown in FIG. 10. Since the auxiliary electrode portions 42B, 43B and the resistor layer 44 both have good heat conductivity, the temperature is increased in large area on the surface. Therefore, the elastic member 61 covering the heating element 40 and the cover 62 is unlikely to be locally heated and contracted. This prevents the external appearance from being degraded.

The present embodiment described above has the following advantages.

(1) The rigid covering member 30 is provided about the rim metal core 19, and the heating element 40 is arranged along the outer surfaces 31o, 32o of the covering member 30. Further, the cover 62 is wrapped about the heating element 40. Also, the hollow portion (air layer) 35 is formed between the rim metal core 19 and a part of the covering member 30 at which the heat generating member (the resistor layer 44) of the heating element 40 is arranged (see FIG. 6). The heat insulating effect of the hollow portion 35 hinders heat transfer from the heat generating member (the resistor layer 44) to the rim metal core 19. Accordingly, an increased proportion of the heat of the heat generating member (the resistor layer 44) is transferred to the cover 62.

(2) The elastic member 61 is located between the heating element 40 and the cover 62 (see FIG. 6). The elastic member 61 prevents the shape of the outer surface of the heating element 40 (the outer surface 410 of the insulation sheet 41) from standing out on the outer surface 62o of the cover 62. Also, when the driver grips the rim 14, the soft elastic member 61 is elastically deformed. Thus, the touch of the cover 62 is improved compared to a case where the cover 62 is directly wrapped about the heating element 40 without using the elastic member 61.

(3) The support members 25 for supporting the covering member 30 to the rim metal core 19 are located between the covering member 30 and the rim-side coupling portion 19A, and at positions where the hollow portion 35 does not exist (FIGS. 4 and 7). The support members 25 allow the covering member 30 to be attached to the rim-side coupling portion 19A, while determining the position of the covering member 30 such that the hollow portion 35 is defined between the covering member 30 and the rim-side coupling portion 19A.

(4) The two support members 25 are located at positions that are between the rim-side coupling portion 19A of the rim metal core 19 and the covering member 30 and at both ends of the covering member 30 along the circumferential direction of the rim 14. The hollow portion 35 is formed between the rim-side coupling portion 19A and the covering member 30 and between the support members 25 (FIGS. 4 and 7). Therefore, when the covering member 30 is attached to the rim-side coupling portion 19A by means of the support members 25, the hollow portion 35 is formed at the same time as the covering member 30 is attached. The formation of the hollow portion 35 is therefore simplified.

(5) The heating element 40 has as its main part the insulation layer 46 and the pair of electrodes 42, 43, which is formed by the insulation sheet 41, the resistor layer 44, the main electrode portions 42A, 43A, and the auxiliary electrode portions 42B, 43B (FIG. 10). Therefore, unlike the sheet-like heat generating member 74 of Japanese Laid-Open Patent Publication No. 2003-317905, in which the heating wires 76 are sewn to the base fabric sheet 75 by means of the upper and lower threads 77, 78 (FIGS. 24 (A) and 24(B)), troublesome sewing operation is not required. The manufacturing costs are therefore reduced.

The temperature of the heating element 40 is increased in a large area on the surface. Therefore, the cover 62 covering the heating element 40 is prevented from being locally heated and contracted. This prevents the external appearance from being degraded.

(6) One surface of the heating element 40 is formed by the adhesive layer 47. Before the elastic member 61 and the cover 62 are wound, the heating element 40 is adhered to the outer surfaces 31o, 32o of the covering member 30 at the adhesive layer 47 (FIGS. 10 and 11). Once adhered, the heating element 40 is not peeled off the covering member 30 or displaced and is maintained at the initial position unless significantly great force is applied. This facilitates the winding of the elastic member 61 and the cover 62.

### Second Embodiment

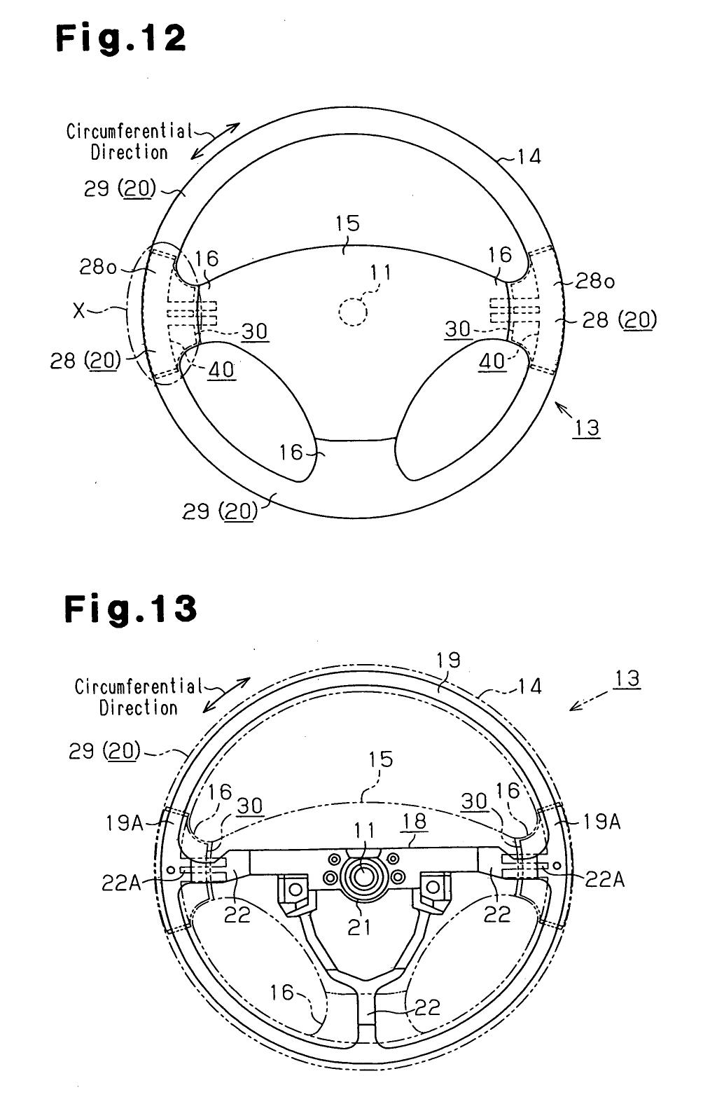

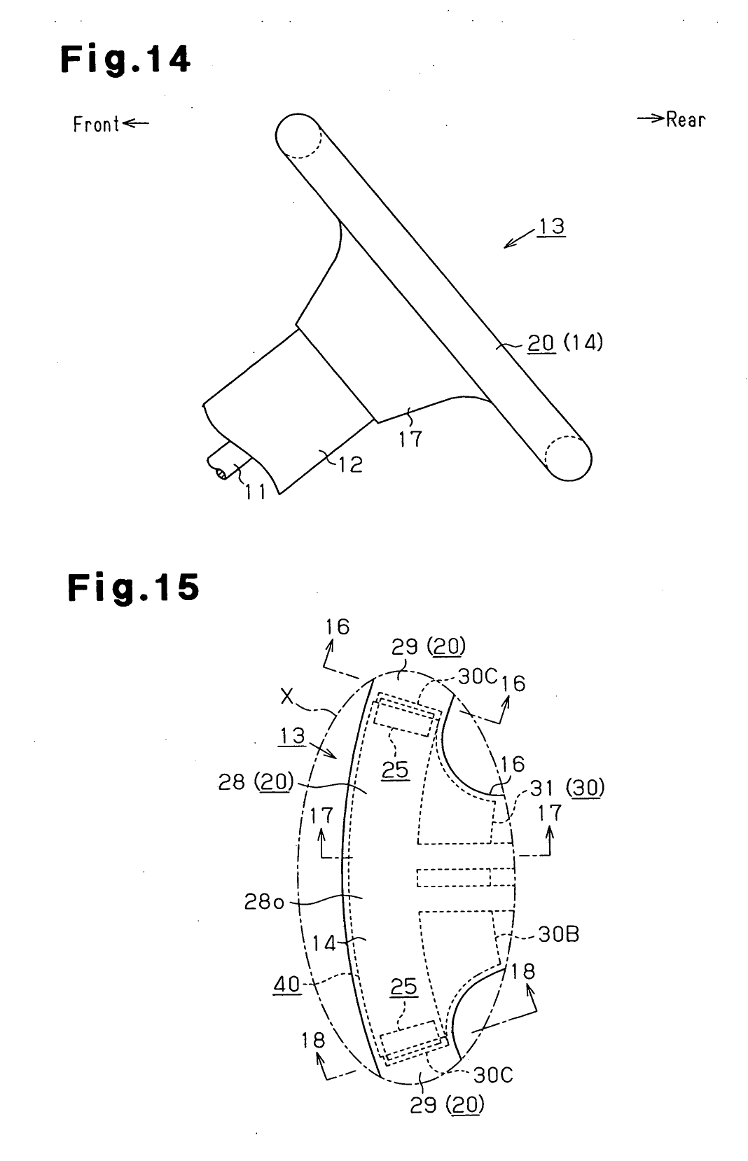

Hereinafter, a steering wheel according to the second embodiment will be described with reference to FIGS. 12 to 23, focusing on differences from the steering wheel according to the first embodiment. The steering wheel according to the second embodiment is different from the steering wheel according to the first embodiment in the structure of the covering portion that covers the heating element 40. Like or the same reference numerals are given to those components that are like or the same as the corresponding components of the steering wheel according to the fifth embodiment.

As shown in FIGS. 12 and 13, the entire rim metal core 19 including both rim-side coupling portions 19A, and the spoke-side coupling portions 22A in the left and right spoke metal cores 22 are directly or indirectly covered with the soft coating portion 20. The soft coating portion 20 is formed of a soft (elastic) material such as foamed polyurethane. The soft coating portion 20 is softer than the covering member 30.

The rim metal core 19 is directly coated with the soft coating portion 20 in parts except for the rim-side coupling portions 19A. The rim metal core 19 is indirectly coated with the soft coating portion 20 in rim-side coupling portions 19A and the spoke-side coupling portions 22A of the spoke metal cores 22. To distinguish the parts that directly coat the metal core and the parts that indirectly coat the metal core in the soft coating portion 20, the latter is referred to as a first coating portion 28, while the former is referred to as a second coating portion 29.

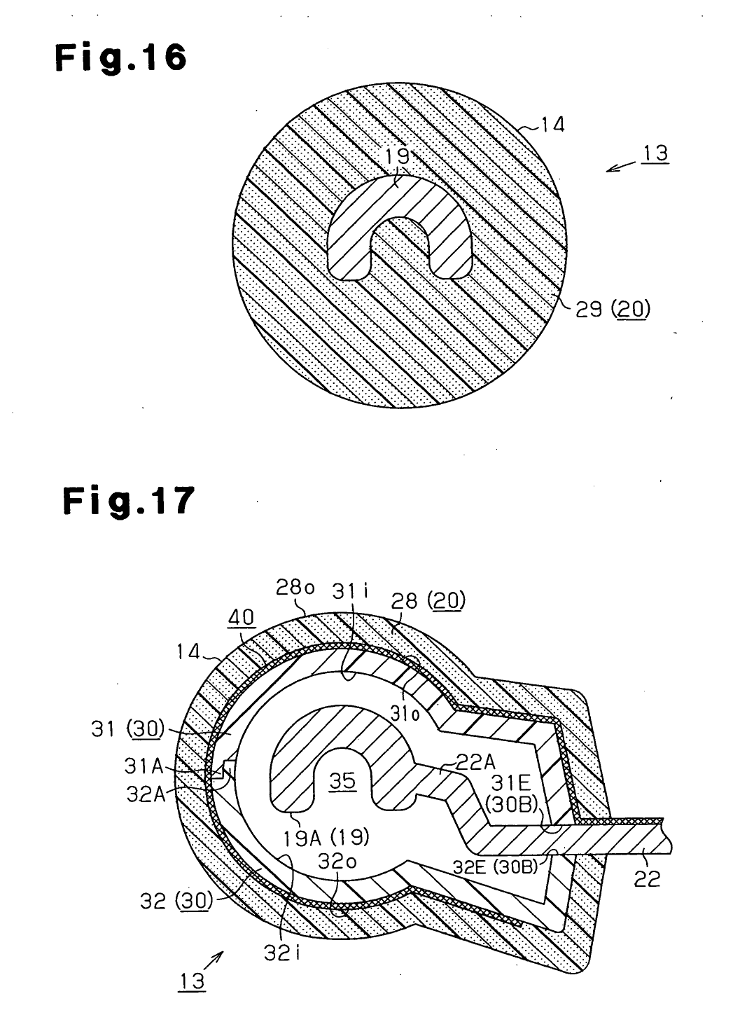

As shown in FIGS. 15 and 16, the second coating portion 29 contacts the rim metal core 19 so as to directly coats the rim metal core 19 at positions spaced from the rim-side coupling portion 19A (see FIG. 13) along the circumferential direction of the rim 14 (upward and downward in FIG. 15). The second coating portion 29 is thicker than the first coating portion 28.

The manner in which the first coating portion 28 coats the coupling portions (the rim-side coupling portions 19A and the spoke-side coupling portions 22A) will now be described. The first coating portion 28 functions as the coating layer of the present invention.

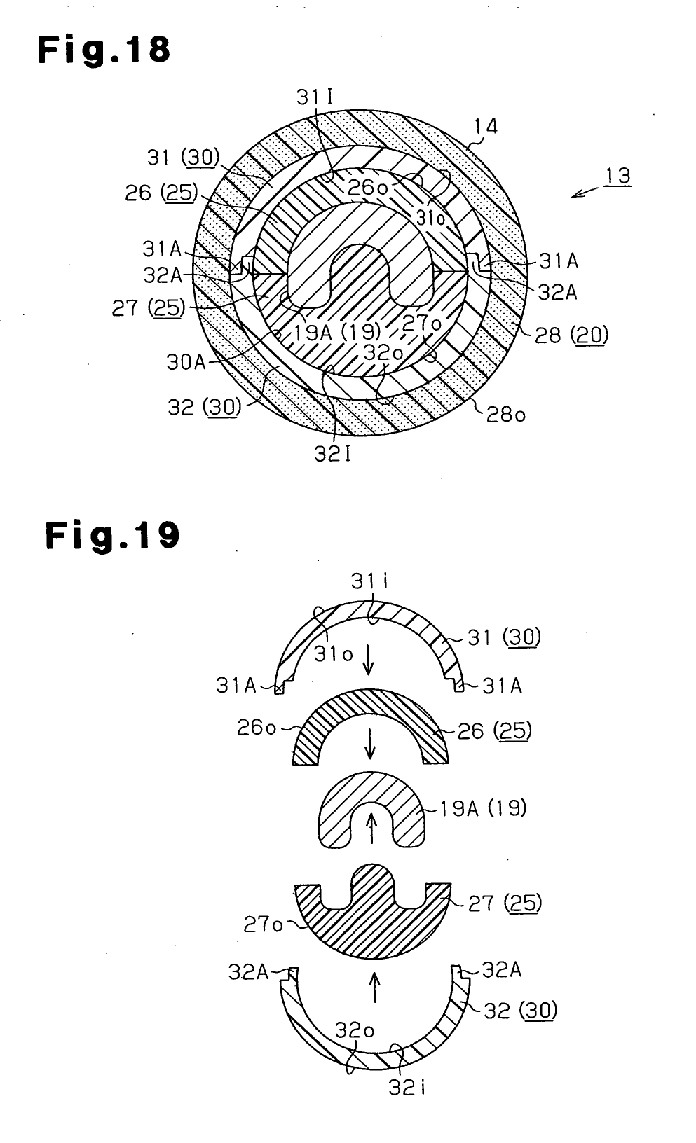

As shown in FIGS. 17 to 19, the covering member 30 covers a part of the rim metal core 19 and a part of the spoke metal core 22. Therefore, the covering member 30 has an opening 30C at the boundary between the rim-side coupling portion 19A and the remaining portion in the rim metal core 19, that is, at each end of the rim 14 in the circumferential direction (see FIGS. 15 and 18). Also, the covering member 30 has an opening 30B at the boundary between the spoke-side coupling portion 22A and the remaining portion in the spoke metal core 22, that is, at an end closer to the boss metal core 21 (right side as viewed in FIG. 17).

At both ends of the covering piece 32 with respect to the circumferential direction of the rim 14, the inner surface 32i closely contacts the outer surface 27o of the support piece 27, and the inner surface 31i of the covering piece 31 closely contacts the outer surface 26o of the support piece 26. The closely contacting support pieces 26, 27 close the openings 30C of the covering member 30. At the opening 30B in the vicinity of the boss metal core 21 of the covering member 30, an end face 31E of the covering piece 31 and an end face 32E of the covering piece 32 closely contact the spoke metal core 22 (see FIG. 17). The region surrounded by the rim-side coupling portion 19A, the spoke-side coupling portion 22A, the covering member 30, and the support members 25 defines a hollow portion 35 (see FIG. 17).

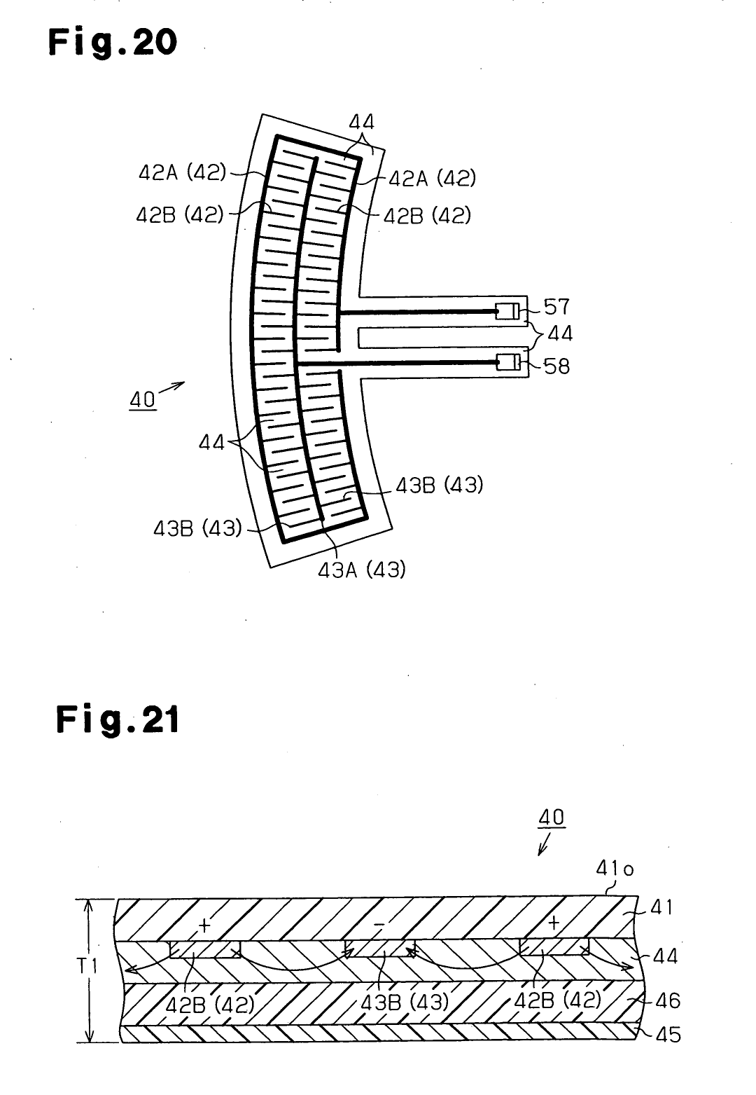

A sheet-like heating element 40 is arranged on the covering member 30 at a part corresponding to the hollow portion 35. The heating element 40 is spread along the outer surfaces 31o, 32o of the covering member 30. FIG. 20 shows the heating element 40 as viewed from rear, and FIG. 21 is an enlarged cross-sectional view of the heating element 40. FIG. 20 shows the heating element 40, without illustrating an insulation sheet 41, which will be discussed below.

As shown in FIGS. 20 and 21, the main portion of the heating element 40 is a flexible sheet having a sheet-like heat generating member that generates heat when electrified. The heating element 40 of the present embodiment has a slightly greater rigidity than the heating element 174 of the second prior art, in which the heating wires 177 are arranged on the fabric sheet 176 (see FIG. 26). The heating element 40 includes an insulation sheet 41 serving as an insulative substrate, a pair of electrodes 42 and 43, a resistor layer 44, an adhesive layer 45, and an insulation layer 46, and has a thickness of 0.2 to 0.3 mm as a whole.

The insulation sheet 41 forms the outermost layer of the heating element 40. The insulation sheet 41 is formed by an insulation film such as a polyester film, and has flexibility as a whole. The outer surface 410 of the insulation sheet 41 forms the outer surface of the heating element 40.

A pair of power supply terminals 57, 58 is fixed to the insulation sheet 41 by means of fasteners such as grommets. The power supply terminals 57, 58 are each electrically connected to the corresponding one of the electrodes 42, 43 by means of the grommet. The power supply terminals 57, 58 are arranged in the pad 15 and connected to an electronic control unit (not shown), which controls electricity supplied to the heating element 40.

The insulation layer 46 is formed by an insulation film such as a polyester film, and has flexibility. The insulation layer 46 coats and protects the resistor layer 44.

The adhesive layer 45 forms the innermost layer of the heating element 40 and is provided, for example, over the entire insulation layer 46. The adhesive layer 45 is formed of insulating adhesive compound. The adhesive layer 45 adheres the heating element 40 to the outer surfaces 31o, 32o of the covering member 30 (see FIG. 17).

As illustrated in FIG. 17, at the rim-side coupling portion 19A and the spoke-side coupling portion 22A, the entire covering member 30 and most of the heating element 40 are coated with a first coating portion 28, which is made of a soft (elastic) material such as foamed polyurethane. The first coating portion 28 indirectly coats the rim-side coupling portion 19A of the rim metal core 19 and the spoke-side coupling portion 22A of the spoke metal core 22. The outer surface 28o of the first coating portion 28 has no visible asperities and is a smooth surface.

The first coating portion 28 preferably has a thickness of 3 to 4 mm. The reason for this is as follows. If the thickness is less than 3 mm, the first coating portion 28 can be no longer elastically deformed even if the driver grips it with a slightly strong force (which gives the driver hard-surface-contacting sensation). Therefore, the tactile sensation is deteriorated. In addition, if the molding material, which will be discussed below, can be insufficiently supplied to parts in a cavity 50A of a molding apparatus 50 for forming the first coating portion 28, defective molding may occur. If the thickness is greater than 4 mm, it takes a relatively long time from when the heating element 40 starts being electrified to when the temperature of the first coating portion 28 is increased to a predetermined level.

The manufacture of the steering wheel 13 having the above described configuration will now be described with reference to FIGS. 18, 22, and 23. First, the support piece 27 is fitted from the front to each end of the rim-side coupling portion 19A with respect to the circumferential direction of the rim 14, and the support piece 26 is fitted from the rear. The separating surface of the support piece 27 and the separating surface of the support piece 26 are brought into contact. The contact forms the annular support member 25 at either end of the rim-side coupling portion 19A with respect to the circumferential direction of the rim 14.

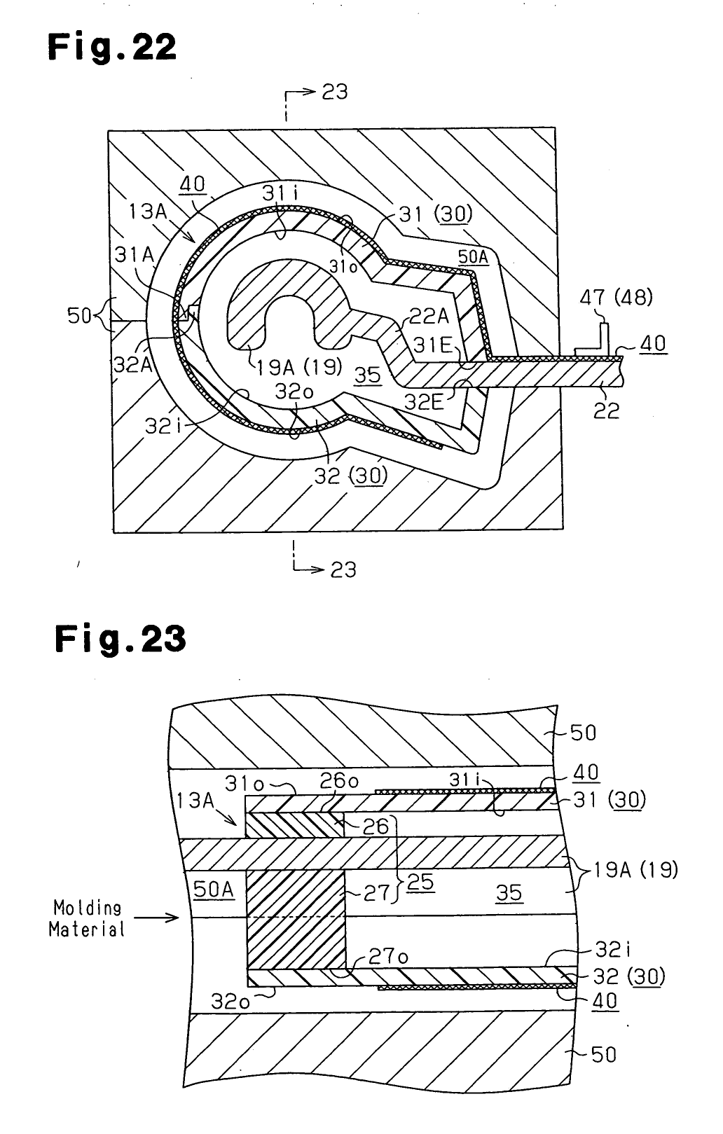

Subsequently, the covering piece 32 is fitted from the front to each support piece 27, and the covering piece 31 is fitted to each support piece 26 from rear. The engaging portions 31A of the covering piece 31 are engaged with the engaging portions 32A of the covering piece 32. The engagement causes the covering member 30 to be attached to the rim-side coupling portion 19A and the spoke-side coupling portion 22A with the pair of support members 25 in between. At this time, the pair of support members 25 forms the hollow portion 35 (see FIG. 22) between the rim metal core 19 and the covering member 30, and supports the covering member 30 while determining the position of the covering member 30 relative to the rim metal core 19. Thus, by using the support members 25, the covering member 30 is attached to the rim-side coupling portion 19A and the spoke-side coupling portion 22A, with the hollow portion 35 defined therebetween. The hollow portion 35 is formed at the same as when the covering member 30 is attached to the pair of support members 25. Specifically, the hollow portion 35 is formed at a position between the rim-side and spoke-side coupling portions 19A, 22A of the metal core and the covering member 30, and between the support members 25.

Further, as shown in FIGS. 22 and 23, the heating element 40 is adhered to the outer surfaces 31o, 32o of the covering member 30 and the spoke metal core 22 at the innermost adhesive layer 45 (see FIG. 21), while being flexed to conform to the covering pieces 31, 32 and the spoke metal core 22. Although the heating element 40 of the present embodiment has flexibility, the heating element 40 is less flexible than the heating element 174 (see FIG. 26) of the second prior art, in which the fabric sheet 176 and the heating wires 177 are combined. Therefore, compared to the prior art shown above, the heating element 40 can be easily and reliably adhered to predetermined positions of the covering member 30 and the spoke metal core 22 without making wrinkles. Once adhered, the heating element 40 is not peeled off the covering member 30 and the spoke metal core 22 or displaced and is maintained at the initial position unless significantly great force is applied.

The steering wheel 13 at this state will be referred to as a steering wheel intermediate 13A.

The steering wheel intermediate 13A is set in the molding apparatus 50 for Reaction Injection Molding (RIM) as illustrated in FIG. 22. The molding apparatus 50 is clamped so that a molding space (cavity 50A) for forming the soft coating portion 20 is defined in the molding apparatus 50 mainly about the rim metal core 19 of the steering wheel intermediate 13A. In this state, since the heating element 40 is adhered to a predetermined part of the covering member 30 and the spoke metal core 22, no operation is required for determining the position of the heating element 40.

Subsequently, liquid molding material, which is made by mixing predetermined ingredients, is supplied to the cavity 50A. The supplied molding material undergoes reaction (foams) to form the soft coating portion 20 at a part of the steering wheel intermediate 13A, mainly at a part corresponding to the rim metal core 19. More specifically, in parts of the rim metal core 19 that are away from the rim-side coupling portions 19A with respect to the circumferential direction of the rim 14, the second coating portion 29 is formed to contact the rim metal core 19 (see FIG. 16). At the rim-side coupling portion 19A and the spoke-side coupling portion 22A, the first coating portion 28 is formed to contact large areas of the covering member 30 and the heating element 40 (see FIG. 17). The first coating portion 28 is formed not to contact the rim-side coupling portion 19A and the spoke-side coupling portion 22A, which are covered with the covering member 30.

The covering member 30, which is formed by engaging the pair of covering pieces 31, 32 together, has the opening 30C at either end with respect to the circumferential direction of the rim 14 (see FIG. 15). If the openings 30C are not closed, molding material in a liquid or gel state can flow into the covering member 30 through the openings 30C.

However, in the present embodiment, the support member 25 is placed between each end of the covering member 30 and the end of the rim-side coupling portion 19A with respect to the circumferential direction of the rim 14, so that the openings 30C are closed (see FIG. 18). Further, the support member 25 is formed of rubber or silicone, and closely contacts the outer surface of the rim-side coupling portion 19A as well as the inner surfaces 31i, 32i of the covering member 30. The end faces 31E, 32E of the covering piece 31, 32 closely contact the spoke metal core 22, so that the opening 30C, which is located close to the boss metal core 21 of the covering member 30, is closed (see FIG. 17). Therefore, the support members 25 prevent the molding material from flowing into the covering member 30 through the openings 30B, 30C. This allows the hollow portion 35 to be reliably formed between the rim-side and spoke-side coupling portions 19A, 22A and the inner surfaces 31i, 32i of the covering member 30.

Since the heating element 40 is adhered to the outer surfaces 31o, 32o of the covering member 30 at the adhesive layer 45, the molding material hardly enters between the covering member 30 and the heating element 40. Therefore, the heating element 40 is unlikely to be peeled off or displaced on the covering member 30 due to entering molding material.

After the soft coating portion 20 is molded, the molding apparatus 50 is opened and the steering wheel 13 is removed. When the vehicle starts being driven in the winter under a low outside temperature condition, the heat generating member (the resistor layer 44) of the heating element 40 in the steering wheel 13 is electrified and generates heat. That is, as shown in FIGS. 20 and 21, when the pair of electrodes 42, 43 are electrified through the power supply terminals 57, 58, current flows from the auxiliary electrode portions 42B to the auxiliary electrode portion 43B as indicated by arrows in FIG. 21 in the resistor layer 44, which is formed on the insulation sheet 41 to cover both of the adjacent auxiliary electrode portions 42B, 43B. Accordingly, the resistor layer 44 between the auxiliary electrode portions 42B, 43B generates heat. The resistor layer 44 and the auxiliary electrode portions 42B, 43B both have good heat conductance, the temperature of wide areas on the surfaces increases.

The heat generated by the resistor layer 44 is transferred to the first coating portion 28, which contacts and covers the heating element 40. The heat transfer uniformly increases the temperature of the first coating portion 28 at any part that contacts the heating element 40, so that the temperature is quickly increased to an adequate level for being gripped by the driver.

The rim metal core 19 has good heat conductivity. Thus, if the covering member 30 contacts and covers the rim metal core 19, the heat generated by the heat generating member (the resistor layer 44) of the heating element 40 is likely to be transferred to the rim metal core 19 through the covering member 30. If heat is transferred to the rim metal core 19, the amount of heat transferred to the first coating portion 28 is reduced, accordingly.

However, in the present embodiment, the hollow portion 35 between the covering member 30 and the rim-side coupling portion 19A and the spoke-side coupling portion 22A functions as a heat-insulating layer. The hollow portion 35 prevents the heat generated by the heat generating member (the resistor layer 44) of the heating element 40 from being transferred to the rim metal core 19 through the covering member 30. As a result, a greater amount of heat generated by the heat generating member (the resistor layer 44) of the heating element 40 is transferred to the first coating portion 28.

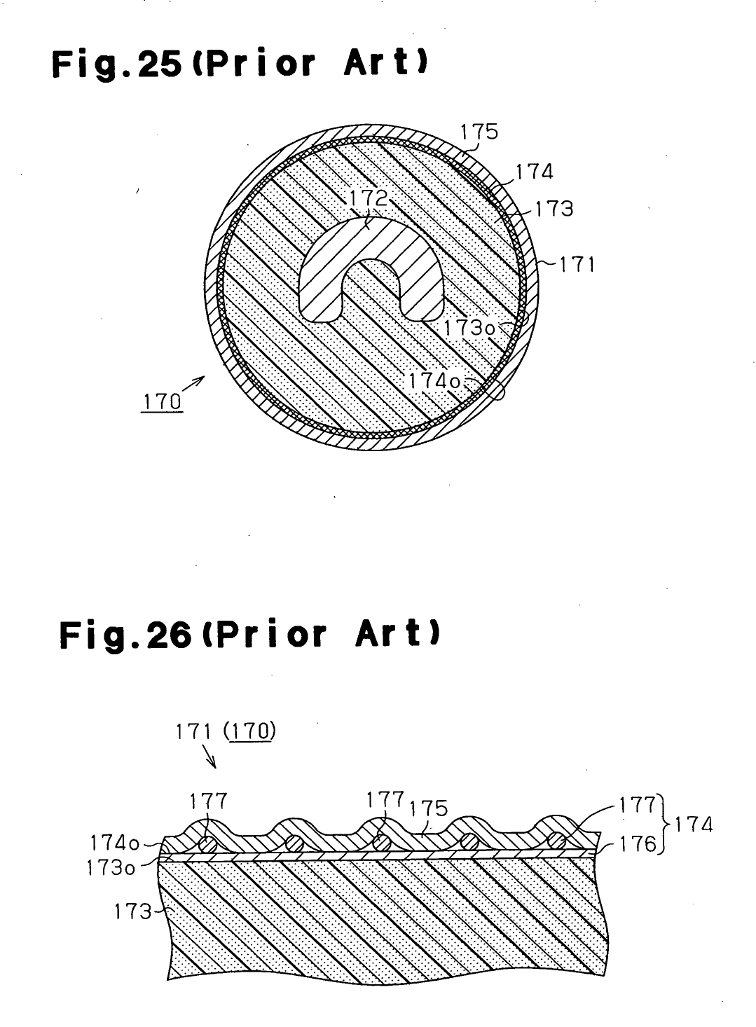

As shown in FIG. 17, the outer surface 28o of the first coating portion 28, which contacts and coats the heating element 40, forms a part of the ornamental surface of the rim 14, or in other words, the ornamental surface of the steering wheel 13. If the shape of the outer surface 410 of the heating element 40 (see FIG. 21) stand out on the ornamental surface, the external appearance is degraded. However, according to the present embodiment, the first coating portion 28 is formed into a desired shape about the heating element 40 through the Reaction Injection Molding. Therefore, unlike the second prior art, in which the cover 175 is wound about the heating element 174 (see FIG. 25), the shape of the outer surface 410 of the heating element 40 hardly stands out on the outer surface 28o of the first coating portion 28.

Further, since the first coating portion 28 is made of foamed polyurethane, which is soft material, and the heating element 40 is a flexible sheet, the shape of the outer surface 410 of the heating element 40 hardly stands out on the outer surface 28o of the first coating portion 28. That is, even if there are conspicuous asperities on the outer surface 410 of the heating element 40, only the inner surface of the first coating portion 28 is formed in accordance with the shape of the outer surface 410 of the heating element 40. Thus, the first coating portion 28 absorbs such asperities and prevents the shape of the outer surface 410 from standing out on its outer surface 280. In the first place, since the outer surface 410 of the insulation sheet 41 of the heating element 40 is smooth (see FIG. 21), asperities due to the heating element 40 are unlikely to be formed on the outer surface 28o of the first coating portion 28.

In the steering wheel 170 according to the second prior art, in which the cover 175 is wound about the heating element 174, which is made by placing the fabric sheet 176 on the heating wires 177 (see FIG. 26), parts of the cover 175 that covers the heating wires 177 are locally heated and contracted. Due to repeated contraction over years, wrinkles will be conspicuous, degrading the external appearance.

However, according to the present embodiment, the resistor layer 44 between the adjacent auxiliary electrode portions 42B and 43B generates heat as shown in FIG. 21. Since the auxiliary electrode portions 42B, 43B and the resistor layer 44 both have good heat conductivity, the temperature is increased in large area on the surface. Therefore, the elastic member 1 covering the heating element 40 and the cover 28 are unlikely to be locally heated and contacted. This prevents the external appearance from being degraded.

Accordingly, unlike the steering wheel 170 according to the second prior art in which the cover 175 is wound, an elastic member made of, for example, rubber does not need to be placed between the heating element 40 and the first coating portion 28.

The present embodiment described above has the following advantages.

(1) The rigid covering member 30 is provided about the rim metal core 19, and the heating element 40 is arranged along the outer surfaces 31o, 32o of the covering member 30. Further, the first coating portion 28 made of soft resin is formed about the heating element 40 and contacts the heating element 40. The heating element 40 is formed through the Reaction Injection Molding and has an outer surface 28o, which serves as an ornamental surface (FIG. 17). Accordingly, the external appearance is prevented from degraded by the heating element 40, and without increasing the number of components. Also, the steering wheel 13 can be assembled from a smaller number of components. This reduces the manufacturing steps required and costs.

(2) The heat insulating effect of the hollow portion 35 hinders heat transfer from the heat generating member (the resistor layer 44) to the rim metal core 19. Accordingly, a greater amount of the heat of the heat generating member (the resistor layer 44) is transferred to the first coating portion 28, so that the rim 14 is efficiently heated.

(3) Prior to the Reaction Injection Molding of the first coating portion 28, each support member 25 is placed between the rim-side coupling portion 19A of the rim metal core 19 and the covering member 30 while closely contacting the outer surface of the rim-side coupling portion 19A and the inner surfaces 31i, 32i of the covering member 30. Therefore, the support members 25 function as sealing members during the Reaction Injection Molding of the soft coating portion 20, so as to prevent the molding material from entering the covering member 30.

(4) The heating element 40 is formed by laminating the insulation sheet 41, the pair of electrodes 42, 43 formed by the main electrode portions 42A, 43A and the auxiliary electrode portions 42B, 43B, and the resistor layer 44 (FIG. 21). Therefore, the first coating portion 28 covering the heating element 40 is prevented from being locally heated and contracted. This prevents the external appearance from being degraded.

(5) The innermost layer of the heating element 40 is formed by the adhesive layer 45. Prior to the Reaction Injection Molding of the first coating portion 28, the heating element 40 is adhered to the outer surfaces 31o, 32o of the covering member 30 at the adhesive layer 45 (FIGS. 21 and 22). When the steering wheel intermediate 13A is set in the molding apparatus 50, the heating element 40 is placed at a predetermined position in the cavity 50A. Therefore, in the Reaction Injection Molding, additional operation for determining the position of the heating element 40 is not required when setting the steering wheel intermediate 13A in the molding apparatus 50. This facilitates the preparation (mainly, setting of the steering wheel intermediate 13A in the molding apparatus 50) performed before the molding material is supplied to the molding apparatus 50.

The present invention may be modified as follows.

### <Regarding Support Members 25>

In each of the above embodiments, the covering member 30 may be fixed to the rim metal core 19 without using the support members 25. In such a case, the fixation may be achieved by, for example, fastening with screws.

### <Regarding Covering Member 30>

In each of the above embodiments, the part of the covering member 30 to which the heating element 40 is adhered may have a shape that gradually changes, instead of a shape that abruptly changes. This modification allows the heating element 40 to be easily flexed along and adhered to the covering member 30.

In each of the above embodiments, it is sufficient if the covering member 30 is provided about at least a part of the rim metal core 19 in the circumferential direction. Thus, the length of the covering member 30 along the rim metal core 19 may be changed to be longer or shorter.

In each of the above embodiments, the positions of the covering member 30 and the heating element 40 in the rim 14 may be changed on the condition that the covering member 30 and the heating element 40 are embedded in the rim 14 at parts gripped by an occupant (driver). For example, the heating element 40 may be embedded in a part that is separated away from the coupling portion between the rim 14 and the spoke 16 or from the vicinity of the rim 14 and the spoke 16.

### <Regarding Hollow Portion 35>

In each of the above embodiments, the hollow portion 35 may be provided only about the rim-side coupling portion 19A, which is, among the rim-side coupling portion 19A and the spoke-side coupling portion 22A, the one surrounded by the heat generating member (the resistor layer 44).

### <Regarding Heating Element 40>

In each of the above embodiments, the adhesive layers 45, 47 on the heating element 40 may be omitted, and the heating element 40 may be attached to the covering member 30 by means of other means such as adhesive agent or screws. The heating element 40 can be attached to the covering member 30 by providing an engaging portion on the covering member 30 and fitting the engaging portion into the peripheral portion of the heating element 40.

### <Regarding Elastic Member 61>

In the first embodiment, the elastic member 61 may be omitted if the shape of the heating element 40 does not stand out excessively conspicuously on the cover 62 or when such appearance is not a problem.

### Other Modification

The present invention may be applied not only to the steering wheel of vehicles, but also to steering wheels of the steering device in other transport vehicles such as airplanes and ships. In this case, such vehicles include not only private automobiles, but also various kinds of industrial vehicles.

Therefore, the present examples and embodiments are to be considered as illustrative and not restrictive and the invention is not to be limited to the details given herein, but may be modified within the scope and equivalence of the appended claims.

1. A steering wheel comprising:
a rim;
a rim metal core that forms the framework of the rim;
a rigid covering member that is provided about at least a part of the rim metal core in the circumferential direction of the rim metal core, the covering member having an outer surface;
a heating element formed by a flexible sheet having a heat generating member that generates heat when electrified, the heating element being arranged along the outer surface of the covering member and having an outer surface; and
a coating layer provided on the outer surface of the heating element, the coating layer being softer than the covering member,
wherein a hollow portion is formed between the rim metal core and a part of the covering member at which the heat generating member of the heating element is located.

2. The steering wheel according to claim 1, wherein the heating element includes:
an insulation sheet;
a resistor layer that is formed on the insulation sheet and serves as the heat generating member;
a pair of electrodes each having a main electrode portion and a plurality of auxiliary electrode portions, the auxiliary electrode portions protruding in a comb-like manner from the main electrode portions, wherein the pair of electrodes is arranged on the resistor layer such that the auxiliary electrode portions of the electrodes are arranged alternately; and
an insulation layer coating the resistor layer and the pair of the electrodes.

3. The steering wheel according to claim 2, wherein the heating element has an adhesive layer located on one surface thereof, the adhesive layer being adhered to the outer surface of the covering member.

4. The steering wheel according to claim 3, wherein the coating layer includes an elastic member and a leather sheet wrapped around the elastic member.

5. The steering wheel according to claim 2, further comprising a support member located at a position that is between the covering member and the rim metal core and is different from the hollow portion, with the support member supporting the covering member.

6. The steering wheel according to claim 5, wherein the support member is one of two support members, the support members being located between the rim metal core and the covering member and at both ends of the covering member with respect to the circumferential direction of the rim, and wherein the hollow portion is a space between the rim metal core and the covering member and between the support members.

7. The steering wheel according to claim 2, wherein the coating layer is made of resin and formed about the heating element through injection molding so as to contact and coat the heating element, the coating layer having an outer surface that forms an ornamental surface of the rim.

8. The steering wheel according to claim 5, wherein the rim metal core has an outer surface, and the covering member has an inner surface, and wherein, prior to the injection molding of the coating layer, each support member is arranged between the rim metal core and the covering member while being brought into close contact with the outer surface of the rim metal core and the inner surface of the covering member.

9. The steering wheel according to claim 2, wherein the coating layer is a soft layer and made of foamed polyurethane.
